(19) United States
(12) Patent Application Publication
(10) Pub. No.: US 2007/0194512 A1
(43) Pub. Date: Aug. 23, 2007

(54) Holder device for manufacturing partial coatings on at least the burner of a lamp bulb

(75) Inventors: Arnd Ritz, Heinsberg (DE); Erich Franzen, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,408

(22) PCT Filed: Mar. 23, 2005
(86) PCT No.: PCT/IB05/50992

§ 371 Date: Sep. 28, 2006

(30) Foreign Application Priority Data
Apr. 1, 2004 (EP) 04101356.6

(51) Int. Cl. B25B 1/22

(52) U.S. Cl. 269/71; 29/760; 29/729; 269/903

(57) ABSTRACT

The invention relates to a holder device for manufacturing partial coatings on at least the burner (4) of a lamp bulb (3), comprising at least a retaining element, an adjustment element, and a screen element, wherein the device has a basic body (1) comprising at least one component, which body comprises at least a hollow space (12) in which a portion of the lamp bulb (3) that is not to be coated can be accommodated with clearance, at least a reference region (11) against which a region of the portion of the burner (4) that is not to be coated can be laid in a defined manner substantially without clearance, and at least a screen (5) that is connected to the basic body (1).

The invention relates to a holder device for manufacturing partial coatings on at least the burner of a lamp bulb, comprising at least a retaining element, an adjustment element, and a screen element.

The holder device, which consists of at least one component, is required in processes for manufacturing partial coatings on lamp bulbs in industrial mass manufacture. The holder device is used in or in combination with a coating equipment which provides the partial coating on the lamp bulb in a thin-film process.

The outer surfaces of the lamp bulbs are provided with functional layers for a wide variety of applications in lighting technology, for example for incandescent lamps as well as for discharge lamps. Examples of such functional layers are UV-absorbing layers on automobile lamps and IR-reflecting layers on halogen lamps. It is characteristic of the applications mentioned above that the coating must or may cover the entire surface area of the lamp bulb, which positively influences the effectiveness of the manufacture of these layers.

Within the scope of the invention, functional layers are deemed to be layers whose main function is to achieve a defined parameter change of a lamp.

An element, such as a retaining element, adjustment element, and screen element, within the sense of the invention is a construction comprising at least one component. For example, a screen element comprises at least one screen, which in its turn may consists of one component or several components.

The primary property of the functional layer in other applications can only be achieved if the coated regions of the surface of the lamp bulb do not cover the entire surface area, i.e. a so-termed partial coating is required.

An example of such applications with partial coatings is found in lamps in which the heat radiation properties are to be partly modified in certain regions, for example for achieving a temperature increase in a defined region in the interior of the lamp in the operational state. In these applications as mentioned here, it is often characteristic that no increased requirements are imposed on the quality of the coating as regards contour (sharpness), dimensions (surface area, thickness), and/or location, because usual deviations do not cause any significant impairments of the functionality of the layer.

Narrower tolerances are to be observed in manufacturing technology if the desired functionality of the layer is to be achieved in other applications. An example of such an application is found in partial reflectorizations of lamp bulbs, which are to guide the light emitted by the incandescent coil or a discharge arc within a given spatial angle so as to achieve a higher efficiency. No exact and sharp layer gradient of the contour of the functional layer can be achieved even through covering of the surfaces to be kept clear by means of screens or product holders which are to prevent a coating of these surfaces. Diffusion or reflection of the coating material, in particular during the coating process, often renders it impossible to maintain narrow manufacturing tolerances in a mass production process.

Such a functional layer of a reflector lamp is described, for example, in DE 102 11 015 A1. This reflector lamp is substantially formed by a light source, in particular in the form of a high-pressure discharge lamp, for example a UHP lamp, a main reflector (secondary reflector), and a primary reflector by means of which light from the light source is reflected onto the main reflector. A functional layer formed as a multiple interference filter constitutes the optically reflecting primary reflector when arranged on a portion of the burner of the lamp bulb.

When this lamp is used for projection purposes, said coating must observe the relevant narrow tolerances in the manufacturing process very accurately if it is to perform its function correctly.

It is furthermore necessary for the transition from the uncoated surface of the lamp bulb, the so-termed light emission window, to the functional layer to be very abrupt, i.e. the transition region of deviating layer thickness, also denoted taper region, must be as small as possible.

In the case of covering, the region of the screen that substantially influences the contour of the light emission window must lie without any clearance against the surface of the burner, if at all possible. This is the object so as to prevent that coating material can enter the region of the light emission window through said clearance.

On the other hand, the screen in full contact has a certain material thickness at its outer edge, even if it is formed as a knife edge, so that a vertical step down to the surface of the burner is present there. The vertical dimension of this step is defined by the clearance width in situ and said material thickness of the edge of the screen. This step causes an inhomogeneity in the layer thickness distribution during the deposition of the coating material owing to a shadow effect in the particle flow. It can be often observed here that the layer thickness at the edge is smallest and gradually reaches the desired value as the distance to the edge increases. The width of this taper region, which often causes appreciable disturbances in the desired functions of the coating, depends mainly on the shape and height of the step. The value of the horizontal dimension of this transition region is often twice to seven times the value of the vertical height of the step. It holds in particular for UHP-type lamps, which have a diameter of 8 to 12 mm in the spherical portion of the burner, that the edge of the screen must be comparatively small, i.e. in particular smaller than 150 μm. Only then can it be achieved that the taper region is kept small in relation to the dimensions of the lamp.

The manufacture of such an opening or partial coating is technologically complicated, in particular in the field of mass manufacture.

Such partial coating is manufactured in the coating process, for example a usual thin-film process, inter alia by means of a mechanical covering of those regions which are not to be coated. Suitable holder devices with mechanical screens are used for this purpose. These devices, which often comprise a plurality of components, serve to position, to retain, and to cover the lamp bulb in a defined manner during the application of the coating. These functions are performed in particular by means of at least one retaining element, one adjustment element, and one screen element.

Such holder devices are exposed to a wide variety of loads in industrial mass manufacture. A particular problem here is formed by the permanence and service life of the holders, in particular their edges that are critical for the function. Damage to these sensitive regions cannot be excluded during handling in the production process. Such unnoticed damage often leads to corresponding defects in the geometry of the coating. Furthermore, the holder device must provide a reliable retention of the lamp bulb in the coating process, while it should at the same time be easy to load and unload so as to be able to achieve short lead times and accordingly an efficient manufacturing process. Very small incorrectnesses in positioning lead to incorrect coatings in the case of the small dimensions required for the taper regions as mentioned above and the associated narrow tolerance requirements.

The retention, the positioning, and covering for realizing this technologically complicated handling has taken place until now by means of respective separate devices or device components, which in particular are moved separately. The functions mentioned above are performed in particular by means of separate retaining elements, adjustment elements, and screen elements.

The use of screens requires that the latter are to be arranged very close to the surface to be coated during the coating process. These screens are suitable for coating processes of low intrinsic directional effect such as, for example, sputtering. The use of such pre-manufactured screens has the following particular disadvantages in applications in which high requirements are imposed on the accuracy and sharpness of the layer: the process necessarily involves that the screens are also coated, so that cleaning or exchange is necessary; the screens render the handling for loading and unloading of the coating device more difficult; and screens with sharp edges or their cutting edges in the μm region, which are necessary for achieving sharp contours, are very sensitive to damage in industrial mass manufacture.

The invention accordingly has for its object to provide a holder device of the kind mentioned in the opening paragraph which renders it possible to manufacture partial coatings of lamp bulbs having a high contour sharpness and accuracy within an industrial mass manufacturing process in an effective manner, and to make available a lamp bulb with such a partial coating as well as a method of manufacturing partial coatings on such lamp bulbs.

The object of the invention is achieved by means of the characterizing features of claim 1.

According to the invention, the basic body comprising at least one component of the holder device according to the invention has at least one hollow space, in which a portion of the lamp bulb not to be coated can be accommodated with clearance, at least one reference region against which a region of the portion of the burner that is not to be coated can be laid in a defined manner substantially without clearance, and at least one screen which is connected to the basic body.

This holder device ensures that the lamp bulb is kept in a predetermined position relative to the screen in a defined manner throughout the entire duration of the process of providing the partial coating. Not only is the lamp bulb securely retained throughout the entire manufacturing process of the coating, but the position of the lamp bulb with respect to the screen, or the edge or tip thereof constituting the taper region, is immovably fixed.

The constructional arrangement chosen for the basic body achieves a centering with respect to the longitudinal axis of the basic body when that portion of the lamp bulb is inserted that comprises the portion of the burner not to be coated on account of its function. The constructional arrangement of the reference region renders it possible to determine the axial penetration of the lamp bulb into the hollow space of the basic body. When the lamp bulb abuts against the reference region, the position of the outer edge of the screen, i.e. the knife edge tip, is defined because the screen is connected to the basic body, said knife edge substantially determining the taper region as regards its spatial arrangement in situ.

The use of the word “exact” in relation to the layer gradient of the contour of the functional layer denotes the degree of correspondence of the actually coated region to what is desired; “sharp” denotes the degree of correspondence of the layer thickness gradient in the region of the contour. The contour has a high sharpness if only a slight taper effect occurs, i.e. the layer thickness differs from the layer thickness of the adjoining layer region only immediately at the contour, as in a knife edge.

The solution according to the invention can be used in principle for all such lamps wherein a functional layer, in particular in the form of a partial coating, is to be provided on the lamp bulb or burner. Said solution is particularly advantageous if increased requirements are imposed on the exact positioning of the functional layer.

The dependent claims relate to advantageous further embodiments of the invention.

It can be achieved by means of a preferred embodiment of the holder device according to the invention that the lamp bulb can be positioned in a defined manner through the interaction between the interlocking abutment against the reference region without clearance and the accommodation with clearance in the hollow space. An abutment with matching shapes is suitable for safeguarding an exact positioning in particular in that case in which the portion of the lamp bulb abutting against the reference region is rotationally symmetrically formed with respect to the longitudinal axis of the lamp bulb. The relevant regions of the lamp bulb and of the reference region correspond with one another as regards their respective shapes in situ.

Alternatively, the solution according to the invention can be utilized also in the case in which the portion of the lamp bulb contacting the reference region is not rotationally symmetrically shaped with respect to the longitudinal axis of the lamp bulb, or is tilted. This renders it possible, for example, to manufacture asymmetrical partial coatings.

It is furthermore preferred that the screen is a wearing part. This may positively influence the cost for holder devices in the manufacturing process.

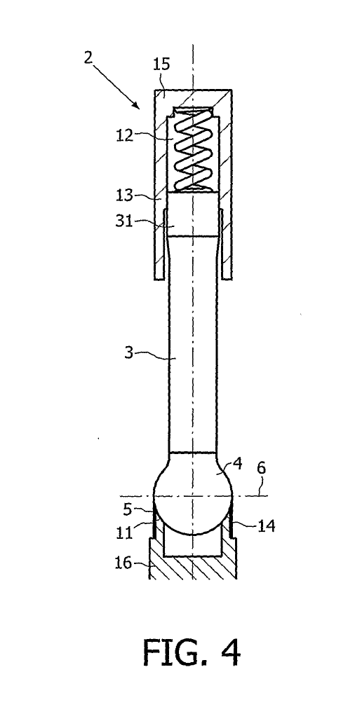

It is furthermore preferred that a basic body comprising several components is used, for example as shown in FIG. 4. The arrangement is suitable for single-ended lamps in this case, where the portion of the lamp bulb at the side of the single lamp base is to be coated.

Preferred is also a basic body comprising several components, where a screen element is to be arranged at each of several components of said basic body.

The object of the invention is furthermore achieved by means of a method of manufacturing partial coatings on lamp bulbs, wherein the functional coatings can be provided in a thin-film process with the use of a device as claimed in claims 1 to 5.

The coating process, for example by means of a spraying process that is known per se, is well suited to industrial mass manufacture, in particular in cases in which the geometrical dimensions of the lamp bulb render this possible.

The holder device according to the invention is used in accordance with its function in this method in the manner as described above.

The object of the invention is furthermore achieved by means of a lamp bulb having a partial coating manufactured by a process as claimed in claim 6.

Further particulars, features, and advantages of the invention will become apparent from the ensuing description of a preferred embodiment, which is given with reference to the drawing in which:

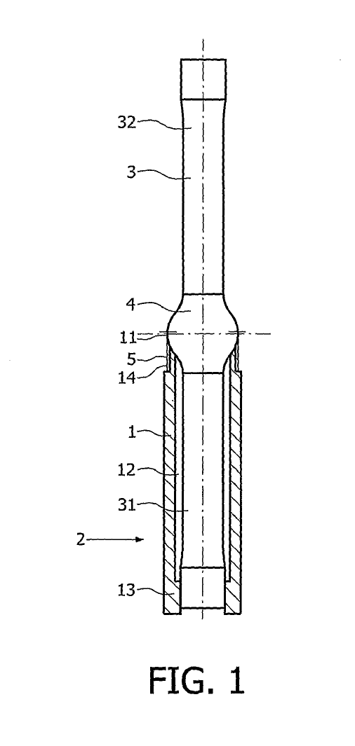

FIG. 1 is a diagrammatic longitudinal sectional view of the basic body of a holder device and a lamp bulb before coating,

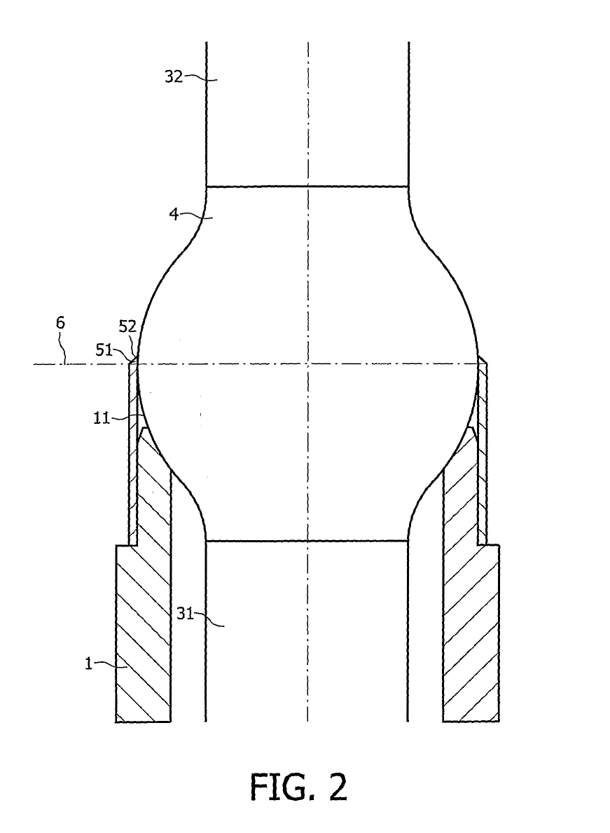

FIG. 2 shows a portion from FIG. 1 with a screen,

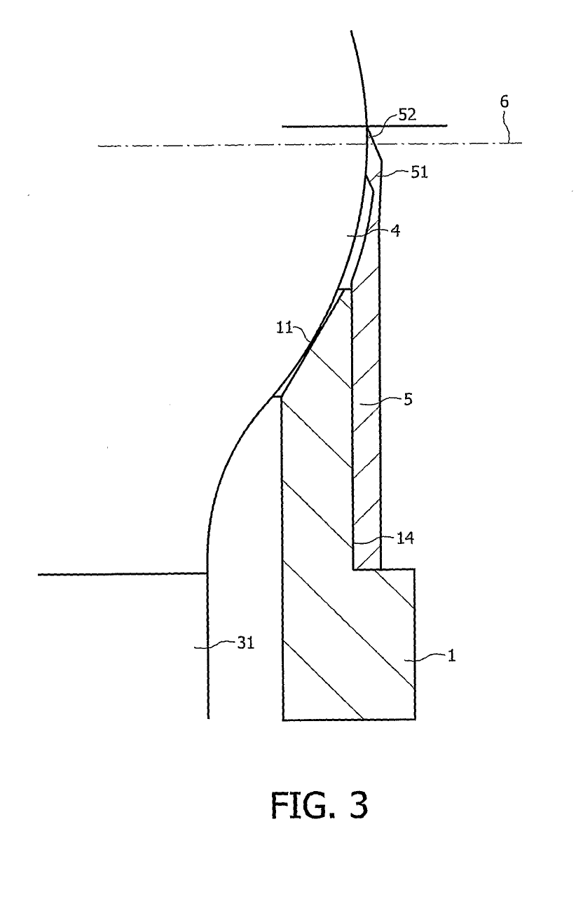

FIG. 3 shows a portion with a different screen, and

FIG. 4 is a diagrammatic longitudinal sectional view of the basic body comprising several parts of a holder device and a lamp bulb before coating.

FIG. 1 is a diagrammatic longitudinal sectional view of the basic body 1 of a holder device 2 with a lamp bulb 3 of a UHP lamp before coating. A multilayer partial coating is provided on the burner 4 in the position shown in FIG. 1 by means of coating in a usual thin-film process.

The basic body 1 of the holder device 2 according to the invention comprises a hollow space 12 which accommodates a portion of the lamp bulb 3 and a portion of the burner 4 which are not to be coated. A portion of the burner 4 lies substantially without clearance against the reference region 11. Otherwise, the basic body 1 and the lamp bulb 3 only have point-shaped contacts with one another.

The substantially symmetrical basic body 1 has a reference region 11 and a positioning aid 13 in addition to the hollow space 12. Furthermore, a fastening 14 for holding a screen element, the screen 5 in this case, is arranged in the upper portion of the basic body 1. The hollow space 12 has a smallest inner diameter in the region of the positioning aid 13. The positioning aid 13 is dimensioned such that the cylindrical region 31 can be inserted with small clearance into the region of the positioning aid 13. The clearance in this location is approximately 0.3 mm, so that the axes of symmetry of the lamp bulb 3 and of the basic body 1 have substantially the same position, at least in the lower region.

The reference region 11 serves for an exact spatial fixation of the burner 4 and thus of the lamp bulb 3 in the upper region. This fixation is achieved in particular by means of matching shapes, because the reference region 11 and the portion of the burner 4 adjoining it there have corresponding shapes. On the basis of this reference region 11, the screen 5 can be positioned anew in a substantially identical manner in each process operation of the coating unit, i.e. a different lamp bulb 3 is coated in each process operation, during which the partial coating can always be provided in the desired position without any adjustment correction.

The fastening 14 serves for reversibly fastening the screen 6 to the basic body 1. This renders it possible that only the screen 5 is to be replaced with a new one, if so required, i.e. in particular when deviations from the admissible manufacturing tolerances on the coating occur. The screen 5 thus acts as a wearing part.

The screen 5 serves for accurately covering that region of the burner 4 that is not to be coated, for example the region of the light emission window.

The screen 5 is connected to the fastening 14 in a known manner by means of matching shapes or by means of clamping forces, but in all cases detachably.

The bulb diameter of the burner 4 is approximately 9 mm, and the dimension of the lamp bulb 3 along its longitudinal axis, at the same time the axis of symmetry, is approximately 50 mm. The burner 4, consisting of quartz glass, is substantially rotationally symmetrically shaped with respect to this longitudinal axis and has only small manufacturing tolerances on its dimensions (approximately +/−0.05 mm). The two cylindrical regions 31 and 32 of the lamp bulb 3 extend from the burner 4. The regions 31 and 32 each have a diameter of 6 mm at the ends.

UHP (Ultra High Performance) lamps, which belong to the high-pressure gas discharge lamps (HID or High Intensity Discharge lamps), are preferentially used inter alia for projection purposes because of their optical properties. The expression “UHP-lamp” (Philips) also denotes UHP-type lamps of other manufacturers within the scope of the invention. The functional coating that is to be provided serves as a so-termed dichroic or cold-beam mirror and is constructed as an interference filter built up from a plurality of layers, often having a total thickness of approximately 0.1 to 20 μm. The reflectorization is a partial coating which leaves a portion of the surface of the burner 4, i.e. the region of the light emission window (not shown in FIG. 1), uncoated in view of its function.

FIG. 2 is an enlarged detail from FIG. 1 with a first embodiment of the screen 5. The screen 5 has the shape of a sleeve which is arranged with its lower, inner side against the fastening 14. A knife edge 51 is provided in the upper portion of the screen 5, tapering towards the burner 4. The screen 5 overlaps the lamp equator 6, i.e. the centerline perpendicular to the longitudinal axis of the lamp bulb 3, by approximately 200 μm. The annular clearance between the burner 4 and the tip 51 of the knife edge 52 is on average approximately 10 μm.

FIG. 3 is an enlarged detail of a further embodiment of a screen 5. This embodiment of the screen 5 differs from that of FIG. 2 in the region adjoining the knife edge 51. It is possible with this embodiment, that is more complicated as regards manufacturing technology, to overlap the lamp equator 6 by more than approximately 200 μm without enlarging the annular clearance, which opens up further design possibilities.

FIG. 4 is a diagrammatic longitudinal sectional view of the basic body of a holder device 2 and the lamp bulb 3 of a high-pressure discharge lamp before coating. A multilayer partial coating is provided on the burner 4 in the position shown in FIG. 4 by means of coating in a usual thin-film process.

The first part 15 of the basic body, formed of several parts, of the holder device 2 according to the invention comprises a hollow space 12 which accommodates a portion of the lamp bulb 3 that is not to be coated. The substantially symmetrical basic body comprises a positioning aid 13 as well as a hollow space 12 in the first part 15. The first part 15 has its smallest inner diameter in the region of the positioning aid 13. The positioning aid 13 is dimensioned such that the cylindrical region 31 can be inserted with little clearance into the region of the positioning aid 13. The clearance in this location is approximately 0.3 mm, so that the axes of symmetry of the lamp bulb 3 and of the first part 15 of the basic body 1 are substantially in the same position. Otherwise, the part 15 and the lamp bulb 3 only have point-shaped contacts with one another.

The second part 16 of the multiple basic body comprises a reference region 11 and a fastening 14 for fastening a screen element, the screen 5 in this case. The fastening 14 serves for reversibly fastening the screen 5 to the second part 16 of the basic body 1.

A ring segment of the burner 4 lies against the reference region 11 substantially without clearance. The reference region 11 serves for an exact spatial fixation of the burner 4, and thus of the lamp bulb 3. This fixation is achieved in particular by means of matching shapes, because the reference region 11 and the portion of the burner 4 lying against it have corresponding shapes. The screen can be positioned anew in a substantially identical manner at each process step of the coating unit on the basis of this reference region 11.

The bulb diameter of the burner 4 is approximately 9 mm, and the dimension of the lamp bulb 3 along its longitudinal axis, which is at the same time the axis of symmetry, is approximately 30 mm. The burner 4, consisting of quartz glass, is shaped substantially rotationally symmetrically with respect to this longitudinal axis and has only small manufacturing tolerances (approximately +/−0.05 mm) on its dimensions. A cylindrical region 31 of the lamp bulb 3 issues from the burner 4. The region 31 has a diameter of 6 mm at its end.

1. A holder device for manufacturing partial coatings on at least the burner (4) of a lamp bulb (3), comprising at least a retaining element, an adjustment element, and a screen element, wherein the device has a basic body (1) comprising at least one component, which body comprises
at least a hollow space (12) in which a portion of the lamp bulb (3) that is not to be coated can be accommodated with clearance,
at least a reference region (11) against which a region of the portion of the burner (4) that is not to be coated can be laid in a defined manner substantially without clearance, and
at least a screen (5) that is connected to the basic body (1).

2. A holder device as claimed in claim 1, characterized in that the lamp bulb (3) can be positioned in a defined manner by means of matching shapes through the interaction of the clearance-free contact against the reference region (11) and the accommodation in the hollow space (12) that takes place with clearance.

3. A holder device as claimed in claim 1, characterized in that the screen (5) is a wearing part.

4. A holder device as claimed in claim 1, characterized in that the basic body (1) has a first part (15) and a second part (16), said first part (15) comprising a hollow space (12) in which a portion of the lamp bulb (3) that is not to be coated can be accommodated with clearance, while the second part (16) has at least a reference region (11) against which a region of that part of the burner (4) that is not to be coated can be laid substantially without clearance in a defined manner.

5. A holder device as claimed in claim 4, characterized in that a screen element is arranged at the first part (15) and/or at the second part (16) of the basic body (1).

6. A method of manufacturing partial coatings on lamp bulbs, wherein functional layers can be provided in a thin-film process with the use of a holder device (2) as claimed in claim 1.

7. A lamp bulb with a partial coating manufactured by a method as claimed in claim 6.

8. A lamp with a lamp bulb as claimed in claim 7.

9. A projection system with at least a lamp as claimed in claim 8.
